(19) United States
(12) Patent Application Publication
(10) Pub. No.: US 2020/0356985 A1
(43) Pub. Date: Nov. 12, 2020

(54) GLOBAL COMBINATION PAYMENT SYSTEM AND METHOD

(71) Applicant: Edward Showalter, Los Angeles, CA (US)

(72) Inventor: Edward Showalter, Los Angeles, CA (US)

(21) Appl. No.: 16/824,489

(22) Filed: Mar. 19, 2020

Related U.S. Application Data
(60) Provisional application No. 62/821,349, filed on Mar. 20, 2019.

(51) Int. Cl. G06Q 20/34; G06Q 30/02; G06Q 20/32; G06Q 20/40

(52) U.S. Cl. CPC G06Q 20/3572; G06Q 30/0229; G06Q 50/02; G06Q 20/326; G06Q 20/405; G06Q 20/322

(57) ABSTRACT

A combination payment system may be a worldwide payment method facilitated by a method which allows users to combine their different payment and financial assets into one amalgamated payment method, thus allowing a user to access and utilize their collective ability to pay. Users may use a combination payment system credit card or a Wi-Fi-connected device, such as mobile phone, tablet, laptop, desktop computer, etc., to make payments. Users may also be provided with digital membership loyalty rewards, which could be redeemed by a user. A user could use the digital loyalty rewards as cash to make purchases or a user could sell the digital loyalty rewards to other users for cash. The combination payment system is also provided with a combination payment platform, which may be an interface through which users may utilize all functions of the combination payment system.

### CROSS-REFERENCE TO RELATED APPLICATIONS

This application claims the benefit of U.S. Provisional Application No. 62/821,349, filed Mar. 20, 2019, which is hereby incorporated by reference, to the extent that it is not conflicting with the present application.

### BACKGROUND OF INVENTION

### 1. Field of the Invention

The invention relates generally to payment methods and more specifically to a method of payment which can utilize both the liquid and non-liquid assets of an individual to purchase goods or services.

### 2. Description of the Related Art

As the global population continues to rapidly grow more and more, Third World countries as well First World countries like China are seeing an emergence of more middle class citizens that are gaining purchasing power to buy First World products.

As well the phenomenon of Cryptocurrency going global has opened up additional methods for consumers to pay for goods, especially in Third World countries where many global citizens don't have bank accounts or credit cards.

Another emerging market for payment systems are Fintech. Lenders like AFFIRM who make instant loans online for consumers to purchase products from merchants. Handling and processing the transaction in a nanosecond.

Yet another payment system that is just exploding worldwide is customers using Wi-Fi devices to make purchases. Like Apply Pay, or Square, as well many others like Paypaw.

Mobile payments are moving the world's consumers toward a cashless economy. The Consumer Financial Protection Bureau's acting chief, Mick Mulvaney wants to give the agency a fresh mission, promoting innovation in consumer finance.

In July 2018 the bureau CFPB has launched a “regulatory sandbox” to help Fintech firms develop new products and services.

Mr . Mulvaney in an interview said he expects the new financial innovation office to look closely at cryptocurrencies, other financial technologies based on blockchain, private currencies, and micro-lending or lending by individuals rather than institutions.

The office also could help companies explore alternatives to traditional credit-scoring methods, such as considering rent and mobile phone payments, consumer shopping behavior and social-media activity in credit decisions. The new technology may actually offer new and innovative ways to protect consumers and merchants.

Many global economies are isolated, especially in Africa and regions in Asia. Mobile-money services have taken off over the past decade in Africa and the Middle East, and regions in Asia. One in 10 adults across Africa—about 100 million people use them.

Hyper inflation and economic isolation have pushed the breakaway republic of Somaliland closer to a virtual milestone that most other countries in the world: a cashless economy.

In Kenya, Vodacom Group Ltd.'s service M-Pesa, broadly considered the first major and most successful mobile-money technology platform, counts 26 million users, roughly half the population. More than half of the world's 282 mobile-money platforms are in sub-Saharan Africa, research by Mckinsey & Company shows.

The Africa continent, home to many of the world's frontier economies, has come closest to “leapfrogging” traditional brick and mortar banks and going straight to heavily using mobile phones as wallets.

In the United States many Americans, over 26 million, live in poverty and do not have bank accounts. These individuals have to go to a check cashing facility to cash their payroll checks. As well many more Americans are trapped in the pay day loan treadmill, not able to break away from that high cost of borrowing.

Globally today, almost all working capital is provided by banks and financial institutions. It can be difficult small companies and individuals to obtain funding at rates that are typically only available to much bigger companies and individuals with high credit scores.

Thus, there is a need for a payment method which utilizes and combines a multitude of payment methods in one mobile phone app.

The aspects or the problems and the associated solutions presented in this section could be or could have been pursued; they are not necessarily approaches that have been previously conceived or pursued. Therefore, unless otherwise indicated, it should not be assumed that any of the approaches presented in this section qualify as prior art merely by virtue of their presence in this section of the application.

### BRIEF INVENTION SUMMARY

This Summary is provided to introduce a selection of concepts in a simplified form that are further described below in the Detailed Description. This Summary is not intended to identify key aspects or essential aspects of the claimed subject matter. Moreover, this Summary is not intended for use as an aid in determining the scope of the claimed subject matter.

In an aspect, a Combo Pay System may be a worldwide payment method facilitated by a method which allows users to combine their different payment and financial assets into one amalgamated payment method, thus allowing a user to access and utilize their collective ability to pay. Users may use a Combo Pay System Credit Card or a WIFI connected device, such as mobile phone, tablet, laptop, desktop computer, etc., to make payments. This may allow consumers and merchants globally to use one payment system that utilizes a combination of their assets to make a payment, wherein a user can preset asset combinations to make different Combo Payment Methods. Users may also be provided with Digital Membership Loyalty Rewards, which could be redeemed by a user. A user could use the Digital Loyalty Rewards as cash to make purchases or a user could sell the Digital Loyalty Rewards to other users for cash, for example.

In another aspect, a Combo Pay System may be provided with a Combo Payment platform (“Combo Pay platform,” “platform”), which may be an interface through which users may utilize all functions of a Combo Pay System. An exemplary Combo Pay platform may be a website through which a user may access the functions and services of the Combo Pay System. The Combo Pay platform website may also have an associated Combo Pay platform application (“Combo Pay app”), such as a mobile application for cell phones and tablets or a desktop application for computers. The functions and services of the Combo Pay System will be evident with the detailed description hereinafter.

In another aspect, the data collected by a Combo Pay System may be amalgamated and secure using blockchain technology, as is known to those of ordinary skill in the art. As an example, the collected data may include user spending habits, user asset balances, member merchant inventory levels, member merchant profits, and so on.

The above aspects or examples and advantages, as well as other aspects or examples and advantages, will become apparent from the ensuing description and accompanying drawings.

### BRIEF DESCRIPTION OF THE DRAWINGS

For exemplification purposes, and not for limitation purposes, aspects, embodiments or examples of the invention are illustrated in the figures of the accompanying drawings, in which:

FIGS. 1A-D illustrate a chart detailing exemplary execution method of a Combo Payment System (“Combo Pay System,” “Global Mobile Combo Payment System,” “GMCPS,” “System”), which can be used globally and in real time, according to an aspect.

FIGS. 2A-D illustrates exemplary blockchain amalgamation of the disclosed Combo Pay system, according to an aspect.

### DETAILED DESCRIPTION

What follows is a description of various aspects, embodiments and/or examples in which the invention may be practiced. Reference will be made to the attached drawings, and the information included in the drawings is part of this detailed description. The aspects, embodiments and/or examples described herein are presented for exemplification purposes, and not for limitation purposes. It should be understood that structural and/or logical modifications could be made by someone of ordinary skills in the art without departing from the scope of the invention.

It should be understood that, for clarity of the drawings and of the specification, some or all details about some structural components or steps that are known in the art are not shown or described if they are not necessary for the invention to be understood by one of ordinary skills in the art.

For the following description, it can be assumed that most correspondingly labeled elements across the figures possess the same characteristics and are subject to the same structure and function. If there is a difference between correspondingly labeled elements that is not pointed out, and this difference results in a non-corresponding structure or function of an element for a particular embodiment, example or aspect, then the conflicting description given for that particular embodiment, example or aspect shall govern.

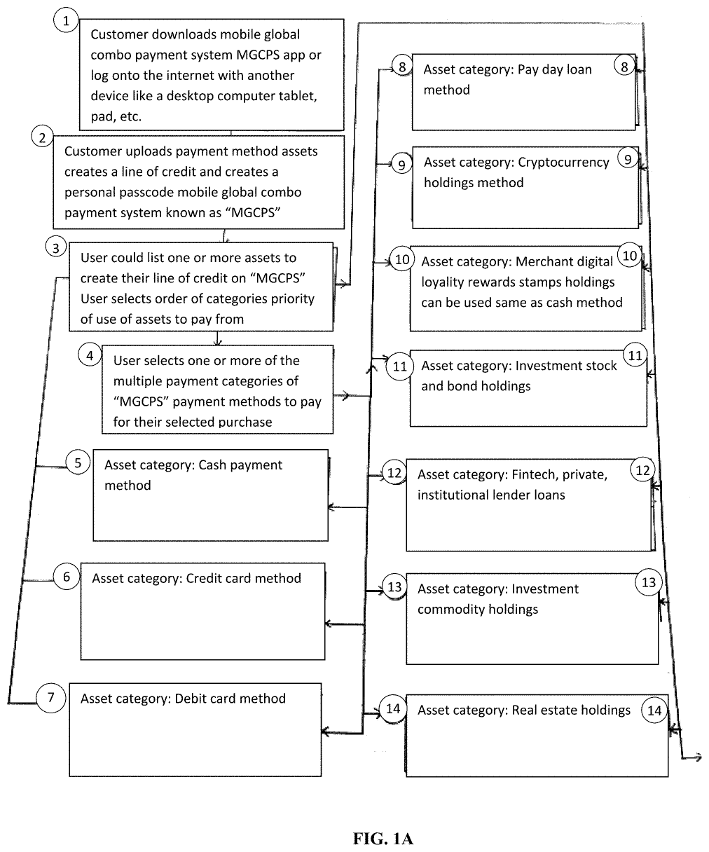

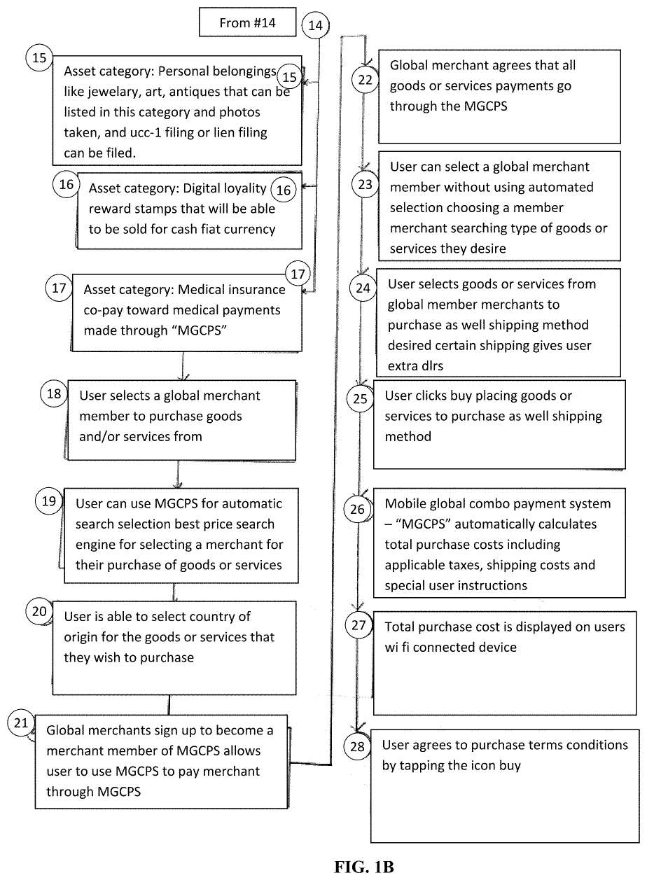

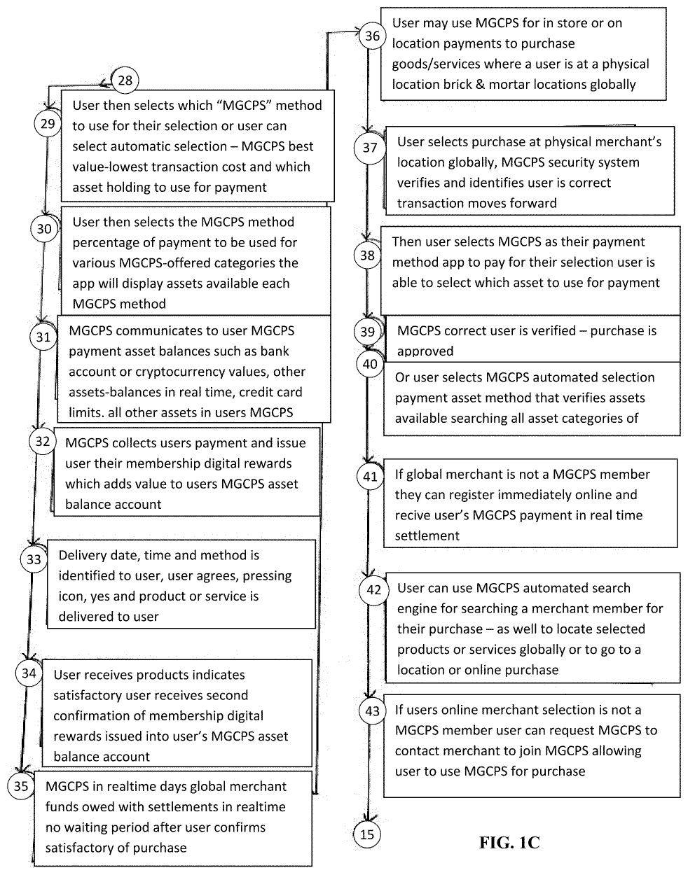

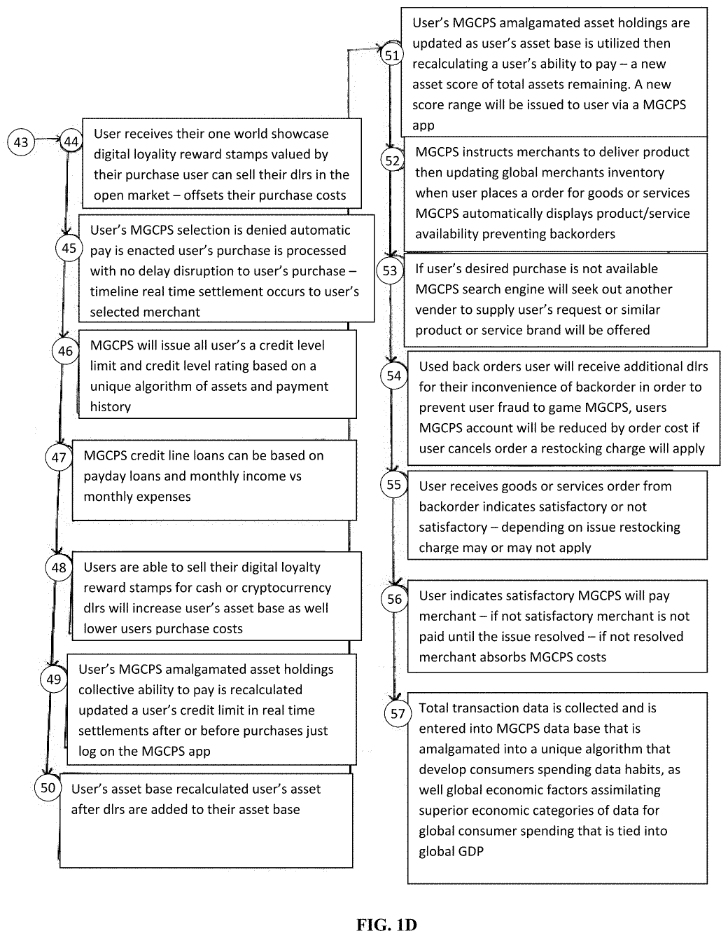

FIGS. 1A-D illustrate a chart detailing exemplary execution method of a Combo Payment System (“Combo Pay System,” “Global Mobile Combo Payment System,” “GMCPS,” “System”), which can be used globally and in real time, according to an aspect.

As an example, users of a Combo Pay System may fall into two categories: (1) merchants (“merchant member,” “member merchant”) or (2) consumers. A merchant may be the owner of a brick and mortar or online store who buys and sells goods or services, for example. A consumer may be a user who purchases merchandise sold by merchant users at their brick and mortar or online stores, for example.

The Combo Payment platform (“Combo Pay platform,” “platform”) may be an interface through which users may utilize all functions of a Combo Pay System. An exemplary Combo Pay platform may be a website through which a user may access the functions and services of the Combo Pay System. The Combo Pay platform website may also have an associated Combo Pay platform application (“Combo Pay app”), such as a mobile application for cell phones and tablets or a desktop application for computers. The functions and services of the Combo Pay System will be evident with the description hereinafter.

A Combo Pay System may be a worldwide payment method facilitated by a method which allows users to combine their different payment and financial assets into one amalgamated payment method, thus allowing a user to access and utilize their collective ability to pay. Users may use a Combo Pay System Credit Card or a WIFI connected device, such as mobile phone, tablet, laptop, desktop computer, etc., to make payments. This may allow consumers and merchants globally to use one payment system that utilizes a combination of their assets to make a payment, wherein a user can preset asset combinations to make different Combo Payment Methods (“Combo Payment Vehicle,” “Payment Asset Method,”), as disclosed in greater detail hereinafter. Users may also be provided with Digital Membership Loyalty Rewards (“Membership Digital Rewards,” “Digital Loyalty Reward,” “World Showcase Digital Loyalty Reward Stamps,” “Digital Loyalty Reward Stamps,” “DLRS”) , which could be redeemed by a user. A user could use the Digital Loyalty Rewards as cash to make purchases or a user could sell the Digital Loyalty Rewards to other users for cash, for example.

As an example, the Combo Pay System can allow farmers or other merchants to purchase seeds, feed for farm animals, or inventory for their businesses. The Combo Pay System may allow merchants or consumers to receive instant short-term loans to purchase goods, which can be automatically paid off as the merchant sells said goods. As an example, the short-term loans can come from Financial Technology (“Fintech”) lenders, institutional lenders, personal lenders or Payday lenders, as disclosed in greater detail hereinafter.

What follows is an exemplary method of executing/creating a global Combo Pay System, which is illustrated by the flowchart shown in FIGS. 1A-D.

A user first goes to the Combo Pay platform website or downloads the COMBO PAY platform App to their Wi-Fi connected device (step 1), such as a Smartphone, Tablet, etc., and creates or signs into a Combo Pay System account (“Combo Pay account,” “account”). Next, a user will create a line of credit by uploading the different payment methods they wish to use with their Combo Pay account and create personal passcode identifiers (step 2). It should be noted that a user can upload payment assets from one or more payment categories, and that the user can set an order of priority which uploaded payment is used first (step 3). In other words, once a user uploads the payment types they wish to use on their account, the user can select which payment is used first. For example, if a user makes a purchase for $50 dollars, then the $50 will be taken from the first priority asset, and if the first priority asset has insufficient funds, then the $50 will be taken from the second priority asset. It should be understood that if a user can upload multiple payment assets within each category, and the order of priority is set to the specific payment asset rather than a payment category. It should also be understood that the payment assets a user uploads will determine the credit limit for the user's line of credit.

To upload a payment asset, a user first selects a payment category (step 4) from a list of payment categories. Exemplary payment categories (steps 5-14) of Combo Pay System are: (step 5) cash, such as fiat currency, U.S. dollar, CASH Vehicle Methods, Hard Sovereign Currency, Bank Checks, Bank Debit Cards, Travelers Checks, Western Union, Bank Wire Transfer, or Money Grams; (step 6) credit cards, such as VISA Credit Card, MASTERCARD CreditCard, Discover Card Credit Card, or American Express Credit Card; (step 7) debit cards; (step 9) Cryptocurrency, such as Bitcoin, Ether, Block. One, Telegram, File coin, or any cryptocurrency that coin base is trading; (step 10) Customer Loyalty Rewards which can be used same as cash, such as World Showcase—World Membership Stamps (WMS), World Showcase—World Xtra Stamps (WXS), Airline Frequent Flyer Mile Rewards, Hotel Rewards, Restaurant Rewards, or any merchant rewards that have a hard currency value and can be traded for U.S. Dollars, or a Foreign Currency; (step 11) stocks and bonds, i.e., stocks that are traded on NASDAQ, NYSE, Hong Kong Exchange, or any foreign stock where stocks in publicly traded companies can be traded for U.S. Dollars, such as Apple, Microsoft, Amazon, ABINBEV, or any stocks that could be used as collateral for an instant loan to complete a user's purchase; (step 12) fintech lenders, institutional lenders, or personal lenders, such as AFFIRM, Prosper, Lending Club, Wells Fargo Bank, Chase Bank, Regional and local banks, Credit Unions, or any Licensed Bank; (step 13) commodities, such as Gold, Silver, Oil, Sugar, Soybean, or any other Commodity that could be leveraged as collateral for an instant loan to complete a user's purchase; (step 14) Real Estate Holdings, such as Personal Home, Commercial Real Estate, Income Property, or any Real Estate that could be leverage as collateral for an instant loan to complete a user's purchase; (step 15) personal belongings, such as jewelry, art, antiques, and so on; (step 16) digital merchant loyalty reward stamps, which can be sold for cash fiat currency; (step 17) Medical Co-Pay Insurance, i.e., if a user has medical co-pay of $10.00 for a prescription, then the user could use a payment method such as a credit card to pay the $10.00 co-pay portion and the medical co-pay insurance to cover the rest of the prescription purchase; and (step 8) Pay Day Loans, i.e., a user could receive advanced funds from a payday lender for a purchase, wherein the payday loan is repaid on a user's payday when the user's paycheck direct deposited into one of the Combo Pay System member banks or wherein the payday loan is repaid when a user presents proper ID and employment verification to deposit a paycheck into a user's bank account at a Combo Pay System member bank.

When a user, consumer or merchant, wishes to make an online purchase using the e-commerce portion of the Combo Pay Platform, the user must first select a merchant member on the platform to purchase from (steps 18). If the user but does not have a particular merchant member in mind, then the user can search the e-commerce portion of the Combo Pay Platform for the goods or services they wish to purchase. Then the Combo Pay Platform will automatically select a merchant member, using closest location to user, even if user is in a foreign country (step 19). Alternatively, the Combo Pay Platform may suggest a list of member merchants and the user can then choose a member merchant (step 23). To filter the search result, a user can select a country of origin for the goods or services (step 20). For example, a user can filter for goods made in America or Italy if user is searching for high quality shoes, or goods made in China if user might be searching for a best bargain priced item.

If the user selects a merchant who is not a member of the Combo Pay System, then the merchant can sign up to become a merchant member, thus allowing the user to pay for the goods or services though the Combo Pay System (step 21). After the user purchases goods from another merchant member (or from an external merchant), then the user can post their merchandise, such as goods or services, for sale on the Combo Pay Platform. For example, the user may be a farmer who purchases soybean seeds from a merchant member. Then, the farmer could post their soybeans on the Combo Pay Platform once they are grown and ready to sell.

For a merchant to become a member and sell goods or services though the Combo Pay System, the merchant must agree that all payments the merchant member receives for sold merchandise will go through the Combo Payment System (step 22). Additionally, a merchant member must apply and agree to the terms and conditions of the Combo Pay System. To post goods or services for on the Combo Pay Platform, the merchant member to list their items for sale by setting pricing, shipping terms, return policy. Alternatively, a merchant member can provide a link to their online website, which can be linked to the Combo Pay Platform or simply use the Combo Pay System to process sales, that lists their items for sale.

Once a user selects an online e-commerce merchant member form the Combo Pay Platform, the user is ready to go shopping and select items they wish to purchase from the merchant member. A user will select an item to purchase, then select a shipping method offered by the Merchant Member the user is purchasing from (step 24). To buy the items, a user can place the items in the Combo Pay Platform shopping cart and click buy (step 25).

Once the user clicks buy, the Combo Pay Platform will automatically calculate the purchase price total and adds any applicable government tax to the total purchase (step 26). The total cost to the user will then be displayed on the user's WIFI connected device that they are using to purchase the online items (step 27). To finalize the purchase, the user will once agree to the total purchase price by once again clicking a “buy” button on their WIFI device (step 28).

After a user agrees to the total purchase price by clicking buy, the user will be presented with a screen to select which payment method they wish to use (step 29). On the payment method selection screen or the user can select an “automatic best value” option, wherein the Combo Pay System will select which payment methods to use for the best value, or a user can choose any combination of payment methods to complete their purchase. For example, the user can select the percentage of payment method they wish to be pulled from each payment method, such as “50%” fifty percent Visa credit card and “25%” twenty five percent of a bank Debit Card, and “25%” twenty five percent of Merchant Loyalty Rewards (step 30). In doing this, a Combo Pay System user would select exactly which Visa credit card account they wish to use, exactly which brand Bank debit card account they wish to use, and exactly which Merchant Loyalty Rewards they wish to cash in and use.

After the user selects which payment methods to use, the Combo Pay System and Platform will be able to communicate to a user how much asset payment value a user has in each of the payment categories and each exact payment vehicle (i.e., specific bank debit cards, specific loyalty rewards, etc.) has how much available funds to use as a Combo Pay Method (step 31). For example: A user's Visa Credit Card #1 has $3,257 available to be used and a second Visa Credit Card #2 only has $212 available to pay for the purchase. If the total amount the user wishes to purchase is $510, then the Combo Pay System would select Visa Card #1 to pay for the purchase. This method of selection of a Combo Payment Vehicle applies to all the user's Combo Pay System categories.

When the Combo Pay System finalizes the purchase, the System will collect the funds from the user and issue the user their Digital Loyalty Rewards (step 32). Next, the Combo Pay Platform asks a user to confirm to the delivery date, time, and method of delivery and notifies the merchant member to ship the products as well indicates the shipping method (step 33), which could be same day, next day, two day, two hour, ground, air, drone, robotic deliver. If a user indicates that the received products are satisfactory (step 34), then the Combo Pay System will send the merchant the funds (step 35) collected form the user in step 32. It should be understood that, as soon as the transaction clears, it will be posted into the Combo Pay System.

A user can also use the Combo Pay System at a merchant member's physical location (step 36), such as a retail store, restaurant, hotel or airline ticket counter, automotive dealership, movie theater, doctor's office, drug store pharmacy, grocery store, or gas station. Any retailer or service provider or membership club such as golf club or tennis club, or fitness club memberships. First, a user selects their purchase at a physical merchant member's location, then the user's identity is verified by the Combo Pay Platform's security system (step 37). To make the purchase using the Combo Pay System, the user selects a preset Combo Payment Method (“Payment Asset Method”) (step 40) or manually chooses a combination of assets (step 38) to complete the payment, as disclosed when referring to step 30. Next, the identity of the user is verified a second time, by the member merchant for example, and the purchase is approved (step 39). The Combo Pay System could use several personal identifiers such as user's fingerprint, voice recognition, facial recognition, password code or number, birthday, etc. This would allow a user to use the Combo Pay System without using their Wi-Fi connected device.

If the merchant at the physical location is not a member of the Combo Payment System, then the merchant can register online immediately to be able to receive payments form Combo Pay System users (step 41). Alternatively, if the non-member merchant does not want to register, the user can use the search engine on the Combo Pay Platform to find an alternate online or physical member merchant (42). In the event the user is unable to find an online or physical member merchant to make a purchase from, or if the user does not wish to purchase from any of the member merchants suggested by the Combo Pay Platform, then the user can select another non-member merchant and request the Combo Pay System to contact the non-member merchant to join the Combo Pay System (step 43). Thus, enabling to user to purchase from their selected merchant using the Combo Pay System.

Again, after a user makes a purchase, the user will receive their Digital Loyalty Rewards based on the values of the purchase made. Then, the user could sell their Digital Loyalty Rewards on the open market to offset the cost of their purchase (step 44). Selling Digital Loyalty Rewards for cash or cryptocurrency will also increase a user's asset base and lower a user's purchase costs (step 48).

If a user's Combo Pay Method is denied (i.e., one or more of the assets selected for the Combo Pay Method have insufficient funds), then Automatic Pay is enacted, and the purchase is process with no delay or disruption to the user (step 45). Automatic Pay is a function of the Combo Pay System, wherein a short-term loan is issued to a user if they are found to have insufficient funds. The short-term loan can be issued according to the user's credit limit, and the loan could be issued by a fintech lender or pay day lender, for example. It should be understood that each user is issued with a credit limit and credit level rating by the Combo Pay system based on a unique algorithm, wherein the algorithm analyzes the user's assets and payment history (step 46). It should also be understood that short-term credit line loans can also be based on pay day loans, wherein the payday loans are based on a user's monthly income and expenses (step 47).

As an alternate example, each user will have a purchase payment credit level limit, in relationship to their Digital Loyalty Rewards (“World Showcase-World Membership Stamps,” “WMS,” “World Xtra Stamps,” “WXS”) or their Credit Score and social media activity and followers, as well credit availability from Fintech lenders who are Combo Pay System members as, maybe AFFIRM, Prosper.com, lending club.com, Peer-lend.com, etc. This would assist a user to complete their purchase without embarrassment of a denied credit card, or debit card. As another alternate example, the Combo Pay System credit limit could be based on a user's weekly or monthly payday income, where the Combo Pay System would be able to issue payday loans by making funds available to a user at a Western Union location worldwide, or a local bank.

As users make purchases, their asset holdings and credit limit are recalculated by the Combo Pay System and updated to the Combo Pay Platform in real time (step 49) via a blockchain, as is known to those of ordinary skill in the art. A user's asset base is also recalculated and updated after the Digital Loyalty Rewards are added to their asset base (step 50). As a user's asset base is recalculated and updated, a user is issued a new credit level rating (“asset score”) based on the user's updated asset base (step 51).

When the Combo Pay System instructs member merchants to deliver products to consumers, the combo pay system will automatically updates a member merchants' inventory for goods or services and displays the updated inventory on the Combo Pay System (step 52). Thus, reducing the likely hood a user's purchase will be placed on back order. In the event a user's purchase is back-ordered (i.e., the goods or services are not available from the user's selected member merchant), then the Combo Pay System will select another merchant member (“vendor”) to offer the user with similar goods or services (step 53). Additionally, a user will receive additional Digital Loyalty Rewards to compensate a user for the inconvenience a back-order causes (stem 54). It should be noted that, to prevent fraud, the Combo Pay System can reduce a user's account by the back-order cost and charge a restocking fee if a user cancels their order. When a user receives their purchased goods or services and indicates the goods or services are satisfactory, the Combo Pay System may or may not charge a restocking fee (step 55). Additionally, a member merchant will only receive a user's payment from the Combo Pay System once the back-order issue has been resolved (step 56). If the issue does not get resolved, a member merchant will have to absorb the cost.

Thus, it should be understood that, as each purchase is completed, the total transaction dated will be collected and entered into the Combo Pay System Database, where said data will be sent through a blockchain and amalgamated by a unique algorithm. Wherein, the algorithm develops and analyzes a user's spending habits, global economic factors, and global consumer spending, which are tied to the global GDP (step 57).

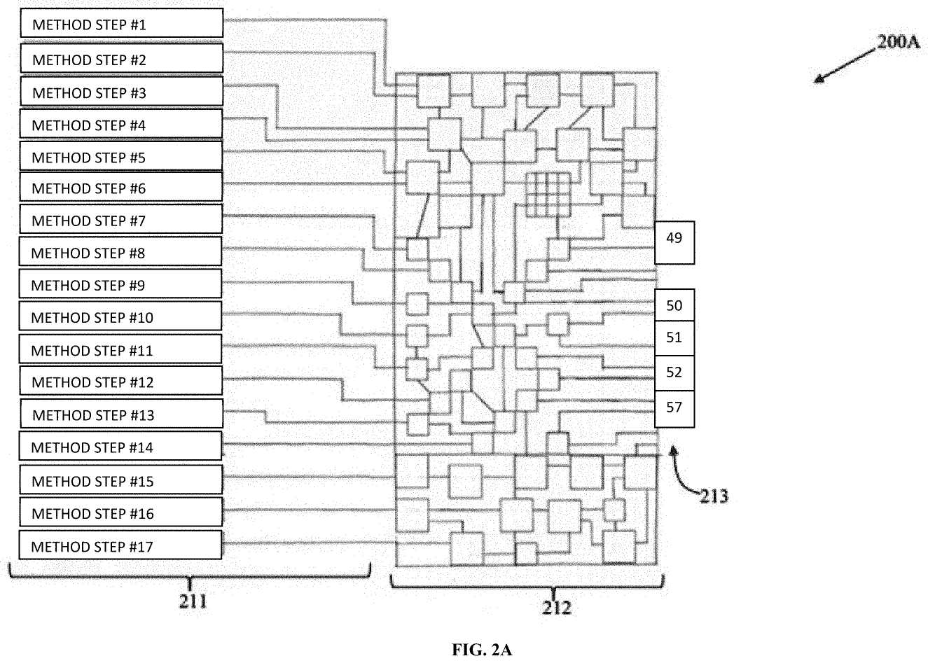

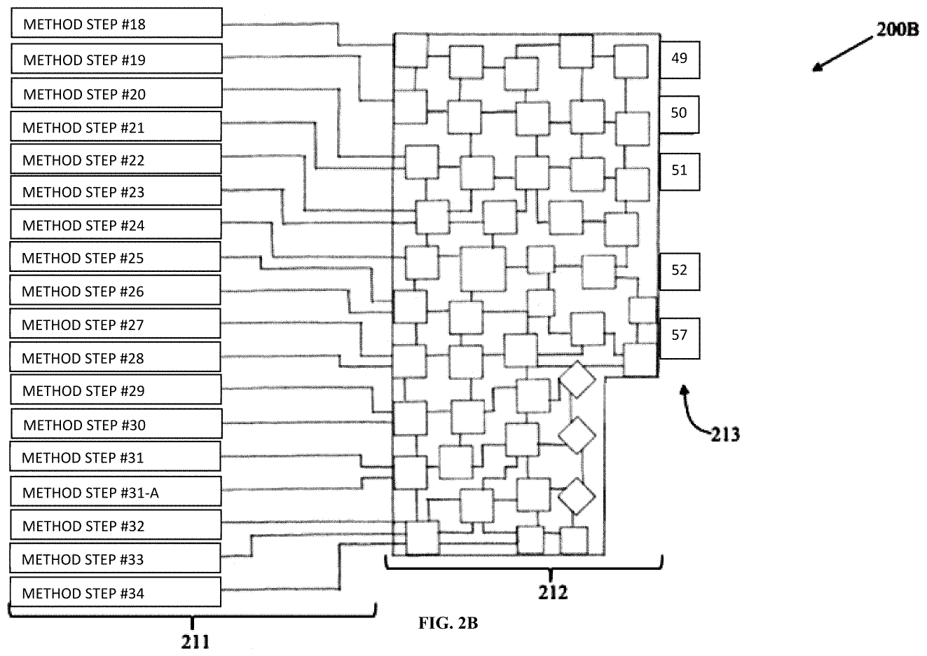

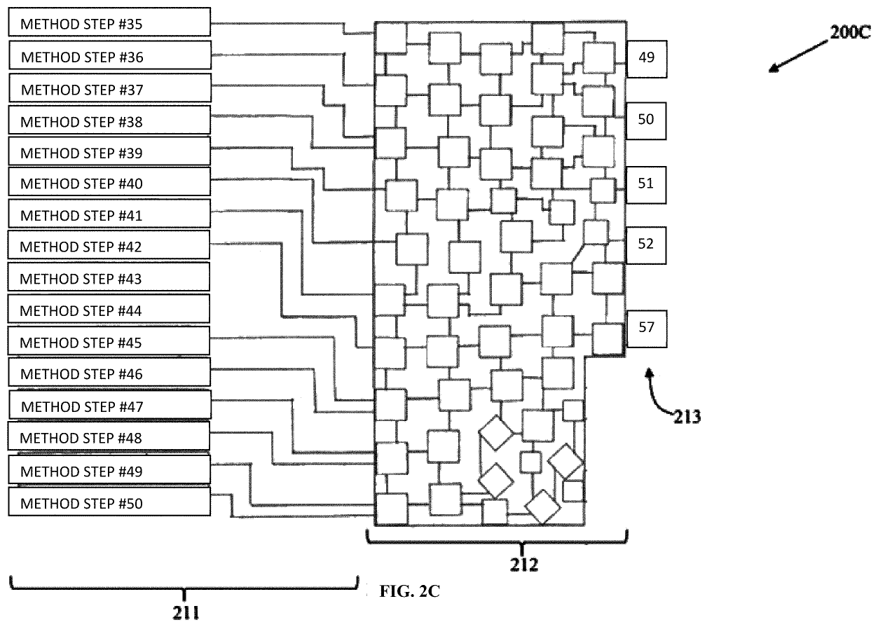

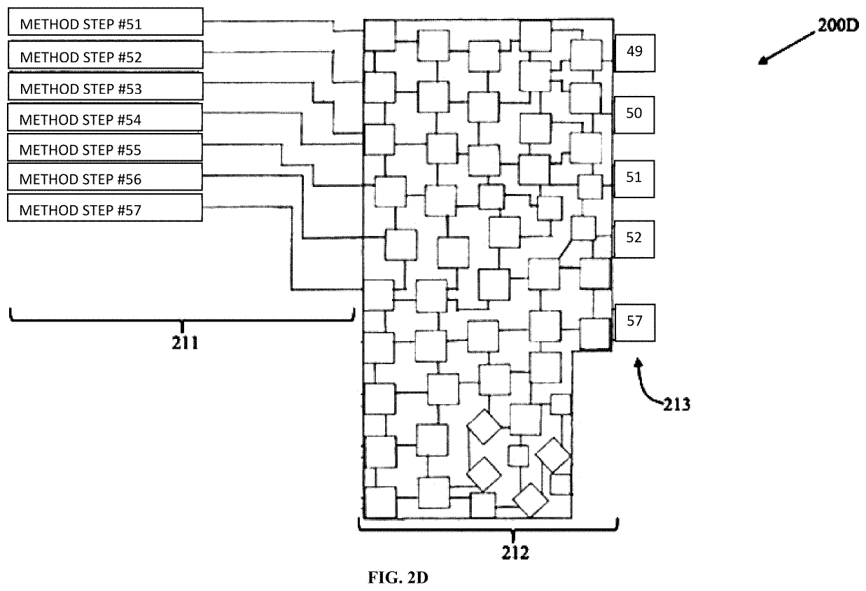

FIGS. 2A-D illustrate an exemplary blockchain amalgamation of the Combo Pay System, according to an aspect. As mentioned hereinbefore, data collect by the Combo Pay System is sent through a blockchain to be amalgamated and secured. FIGS. 2A-D show an exemplary blockchain analysis, wherein the data collected by the Combo Pay System during steps 1-57, as disclosed in the flowchart when referring to FIGS. 1A-D, is input (“input data”) 211 into the block chain 211 and the blockchain outputs (“output data”) secured data. As shown by FIGS. 2A-D, the output data 213 is the data disclosed when referring to steps 49, 50, 51, 52, and 57 of the flowchart of FIGS. 1A-D.

In other words, data collected from users when they register to use the Combo Pay System, upload payment assets, purchase goods or services through the Combo Pay System, and/or sell goods through the Combo Pay System is input 211 into a blockchain 212. Next, the blockchain 212 analyzes the input data 211 and outputs amalgamated, secured data 213. More specifically, the output data 213 can be secured such that the output data 213 does not contain personal information of users or information regarding which user the data came from.

As an example, the output data may be presented to users via the Combo Pay Platform. As another example, the secured output data 213 can be presented to member merchants, so the member merchants can view and independently analyze Combo Pay System user spending habits. Thus, member merchants can optimize their online and/or brink and mortar stores to attract as many consumers as possible.

It may be advantageous to set forth definitions of certain words and phrases used in this patent document. The term “couple” and its derivatives refer to any direct or indirect communication between two or more elements, whether or not those elements are in physical contact with one another. The term “or” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Further, as used in this application, “plurality” means two or more. A “set” of items may include one or more of such items. Whether in the written description or the claims, the terms “comprising,” “including,” “carrying,” “having,” “containing,” “involving,” and the like are to be understood to be open-ended, i.e., to mean including but not limited to. Only the transitional phrases “consisting of” and “consisting essentially of,” respectively, are closed or semi-closed transitional phrases with respect to claims.

If present, use of ordinal terms such as “first,” “second,” “third,” etc., in the claims to modify a claim element does not by itself connote any priority, precedence or order of one claim element over another or the temporal order in which acts of a method are performed. These terms are used merely as labels to distinguish one claim element having a certain name from another element having a same name (but for use of the ordinal term) to distinguish the claim elements. As used in this application, “and/or” means that the listed items are alternatives, but the alternatives also include any combination of the listed items.

Throughout this description, the aspects, embodiments or examples shown should be considered as exemplars, rather than limitations on the apparatus or procedures disclosed or claimed. Although some of the examples may involve specific combinations of method acts or system elements, it should be understood that those acts and those elements may be combined in other ways to accomplish the same objectives.

Acts, elements and features discussed only in connection with one aspect, embodiment or example are not intended to be excluded from a similar role(s) in other aspects, embodiments or examples.

Aspects, embodiments or examples of the invention may be described as processes, which are usually depicted using a flowchart, a flow diagram, a structure diagram, or a block diagram. Although a flowchart may depict the operations as a sequential process, many of the operations can be performed in parallel or concurrently. In addition, the order of the operations may be re-arranged. With regard to flowcharts, it should be understood that additional and fewer steps may be taken, and the steps as shown may be combined or further refined to achieve the described methods.

If means-plus-function limitations are recited in the claims, the means are not intended to be limited to the means disclosed in this application for performing the recited function, but are intended to cover in scope any equivalent means, known now or later developed, for performing the recited function.

Claim limitations should be construed as means-plus-function limitations only if the claim recites the term “means” in association with a recited function.

If any presented, the claims directed to a method and/or process should not be limited to the performance of their steps in the order written, and one skilled in the art can readily appreciate that the sequences may be varied and still remain within the spirit and scope of the present invention.

Although aspects, embodiments and/or examples have been illustrated and described herein, someone of ordinary skills in the art will easily detect alternate of the same and/or equivalent variations, which may be capable of achieving the same results, and which may be substituted for the aspects, embodiments and/or examples illustrated and described herein, without departing from the scope of the invention. Therefore, the scope of this application is intended to cover such alternate aspects, embodiments and/or examples. Hence, the scope of the invention is defined by the accompanying claims and their equivalents. Further, each and every claim is incorporated as further disclosure into the specification.

What is claimed is:

1. A combination payment system as described herein.
